(19) United States
(12) Patent Application Publication
(10) Pub. No.: US 2014/0097345 A1
(43) Pub. Date: Apr. 10, 2014

(54) SCINTILLATION DETECTOR ASSEMBLY

(71) Applicant: SCINTITECH, INC., Shirley, MA (US)

(72) Inventor: Vadim L. Gayshan, Sudbury, MA (US)

(73) Assignee: ScintiTech, Inc., Shirley, MA (US)

(21) Appl. No.: 13/794,429

(22) Filed: Mar. 11, 2013

Related U.S. Application Data
(60) Provisional application No. 61/709,861, filed on Oct. 4, 2012.

(51) Int. Cl. G01T 1/20

(52) U.S. Cl. CPC G01T 1/20
USPC 250/361 R; 250/483.1

(57) ABSTRACT

A scintillation detector assembly sealed via a compression fit without the use of epoxy or other sealant is disclosed. The assembly includes a scintillator composition and a photomultiplier tube optically coupled to the scintillator. A hermetically sealed scintillator container assembly in accordance with the present disclosure includes a cup shaped container sized to receive and hold a scintillator composition. This container has an open end. A metal rim compressively forms a mechanical hermetic seal around a glass window placed over the open end to preclude moisture intrusion into the container and thus prevent exposure of the scintillator crystalline material to degrading moisture. The metal rim is in turn welded to the container.

### CROSS REFERENCE TO RELATED APPLICATIONS

This application claims the benefit of priority of U.S. Provisional Patent Application Ser. No. 61/709,861 entitled Scintillation Detector Assembly, filed Oct. 4, 2012, the content of which is hereby incorporated by reference in its entirety.

### BACKGROUND OF THE DISCLOSURE

Scintillation detectors are used to detect radiation such as gamma, beta, x-ray or alpha radiation. The compositions utilized in scintillation detectors absorb the radiation and, in response, emits photons of light. This light is in turn detected by a photo-detector which produces an electrical signal related to the generated photons which are, in turn, indicative of the intensity or character of the incident radiation. In many applications, the electrical signal produced is very weak and thus a photomultiplier tube may be positioned close to the scintillator composition so as to detect the photons emitted and intensify the electrical output signal. The electrical pulses produced thereby are then shaped and digitized by associated electronics that may be registered as counts and/or transmitted to analyzing equipment for further quantification.

The scintillator composition is often a crystalline material such as sodium iodide (NaI) or cesium iodide (CsI) which is very sensitive to and degraded by a variety of environmental conditions such as mechanical vibrations and are very sensitive to moisture. Consequently such compositions are typically housed within a sealed cup or can. However, in order for the photo-detector to sense emitted light, the enclosure includes a transparent window through which the light can pass. This window is sealed to the can either with an epoxy seal material or the window glass may be first melted and fused to a steel rim which is then in turn welded or brazed to the can. A problem exists with the first method of closure in that, over time, the seal material becomes embrittled and cracks can develop, which can lead to seal failure and moisture intrusion. A problem with the second method of closure is that use of steel for both can and window rim may inhibit scintillation detector sensitivity to lower energy radiation levels.

### SUMMARY OF THE DISCLOSURE

The present disclosure directly addresses this problem. A hermetically sealed scintillator container assembly in accordance with the present disclosure includes a cup shaped container sized to receive and hold a scintillator composition. This container has an open end. A container closure window comprising a circular disc of glass or other optically transparent material is compressively held by an annular rim to form a mechanical hermetic seal to preclude moisture intrusion into the container and thus prevent exposure of the scintillator crystalline material to moisture when the rimed window is then welded to the container open end to close the container.

In a first embodiment the window includes a circular glass disc and a metal annular rim around the edge of the disc. The rim is sized, at normal room temperature, slightly smaller in diameter than the diameter of the circular outer edge of the window disc. When the rim is heated, it expands to accept the window disc therein. As the rim cools, it contracts around the disc, and mechanically compresses against the outer edge of the circular glass disc exerting a residual compressive force on the disc to form the hermetic seal between the glass disc and the rim. The window is then placed on the open end of the container and the rim is then welded to the open end of the container, thus closing the container. The hermetic seal is formed by the mechanical compression contact between the glass window disc and the rim.

In one embodiment, preferably the window glass disc has a layer of aluminum deposited around the outer edge of the window disc prior to mechanically joining the heated rim to the glass disc. In this embodiment, the rim is aluminum. The heated rim is then placed around the window disc and then cooled to hold the window glass disc securely in place. The presence of the aluminum layer improves the mechanical bond between the rim and the window glass edge, hence improving the hermetic seal. The assembly may also include a potting compound layer between the perimeter of the window and the metal rim. The potting compound layer may be a clear epoxy layer.

In one embodiment the window is formed as a glass melt fused inside a metal ring, typically made of steel. A separate metal rim, preferably aluminum, having an internal diameter just equal to or slightly less than the outer diameter of the metal ring is then press fit onto the metal ring, thus compressing against the metal ring to form the hermetic seal. The rim is then welded to the open end of the container to close and seal the scintillator crystal material inside.

Another embodiment of the present disclosure is a scintillation detector assembly that includes a tubular housing, a scintillator subassembly contained within the housing, and a photomultiplier tube having one end positioned against the scintillator subassembly. The photomultiplier tube has a plurality of electrical connector leads protruding from another end. The scintillator subassembly includes the scintillator wrapped with a reflecting material. The photomultiplier tube is optically coupled to the scintillator wrapped with the reflecting material. A glass pass-through disc having a plurality of connector pins mates with the electrical connector leads. The pass-through disc has a metal outer rim that is welded to the housing to hermetically seal the photomultiplier tube and scintillator subassembly within the tubular housing. The metal outer rim is preferably press fit onto the pass-through disc and therefore mechanically compressively fastened to the glass pass-through. This rim is, in turn, welded to the tubular housing to complete the seal and the assembly of the detector.

One embodiment is thus hermetically sealed scintillator container assembly that includes a cup shaped container sized to receive and hold a scintillator composition, the container having an open end; a disc shaped container closure window having a perimeter; and an annular metal rim compressively fit around the window and mechanically pressing against the perimeter of the window so as to form a hermetic seal between the window and the rim, wherein the rim is laser welded to the open end of the container to enclose the scintillator composition within the container. Another embodiment may include a layer of aluminum around an outer rim portion of the window. The window may have a metal ring around an outer rim portion of the window. Alternatively the assembly may include a potting compound layer between the perimeter of the window and the metal rim. The potting compound layer may be a clear epoxy layer.

An embodiment of a scintillation detector assembly in accordance with the present disclosure may include a tubular housing; and a scintillator container assembly in the housing. This scintillator container assembly includes a cup shaped container sized to receive and hold a scintillator composition, the container having an open end; a disc shaped container closure window having a perimeter; and an annular metal rim compressively fit around the window and mechanically pressing against the perimeter of the window so as to form a hermetic seal between the window and the rim, wherein the rim is laser welded to the open end of the container to enclose the scintillator composition within the container within the housing. The tubular housing has within it a photomultiplier tube having one end positioned against the container assembly window. The photomultiplier tube has a plurality of electrical connector leads protruding from other end. A glass pass-through has a plurality of connector pins coupled to these connector leads. Another metal rim is compressively fit around the peripheral edge of the pass-through. This other rim is welded to the housing. The compressive mechanical fit between the pass-through and this other rim hermetically seals the photomultiplier tube and scintillator container assembly within the tubular housing.

Another embodiment of the assembly in accordance with the present disclosure is scintillation detector assembly that has a tubular housing and a scintillator composition contained within the housing. The housing encloses a photomultiplier tube having one end positioned against the scintillator composition, the photomultiplier tube having a plurality of electrical connector leads protruding from another end and a glass pass-through having a plurality of connector pins coupled to the connector leads. A metal rim is compressively fit around the peripheral edge of the pass-through, and the rim is welded to the housing. The compressive mechanical fit between the pass-through and the rim hermetically seals the photomultiplier tube and scintillator composition within the tubular housing of the assembly.

Further features, advantages and characteristics of the embodiments of this disclosure will be apparent from reading the following detailed description when taken in conjunction with the drawing figures.

### DESCRIPTION OF THE DRAWINGS

FIG. 1 is a longitudinal sectional view of a scintillation detector assembly in accordance with one embodiment of the present disclosure.

FIG. 2 is a perspective view of the assembly shown in FIG. 1.

FIG. 3A is an exploded view of the scintillator container separate from the assembly shown in FIGS. 1 and 2 in accordance with a first embodiment of the present disclosure.

FIG. 3B is an assembled perspective view of the assembled scintillator container with a portion in a quarter section.

FIG. 3C is a cross sectional view through the window assembly utilized in the assembled scintillator container shown in FIG. 3A.

FIG. 4 is a separate exploded perspective view of a scintillator container in accordance with a second embodiment of the present disclosure.

FIG. 5 is a separate sectional perspective view of an alternative scintillator container closure window in accordance with the present disclosure.

FIG. 6 is a perspective view with portions in section, of an alternative scintillation detector assembly in accordance with another embodiment of the present disclosure.

FIG. 7 is an exploded view of the assembly shown in FIG. 6.

FIG. 8 is an assembled perspective view of the detector assembly shown in FIGS. 6 and 7.

### DETAILED DESCRIPTION

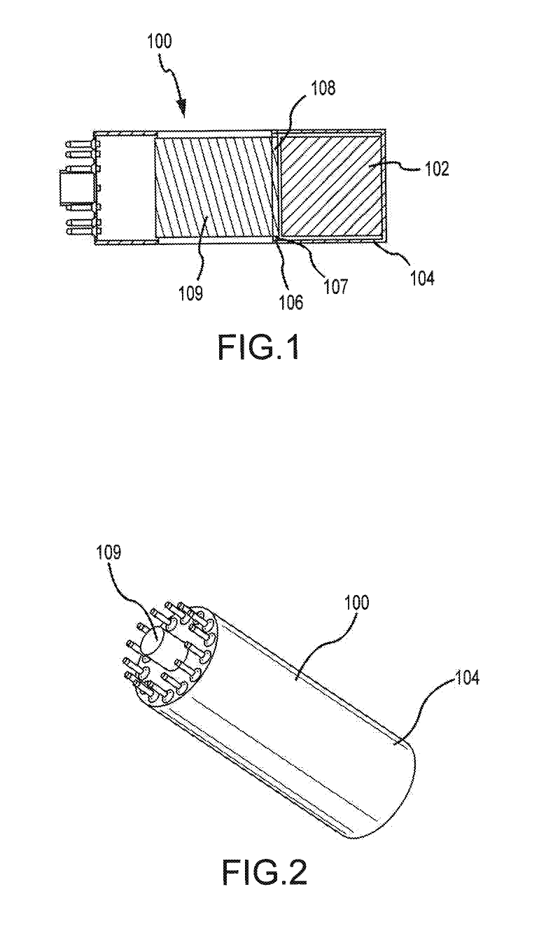

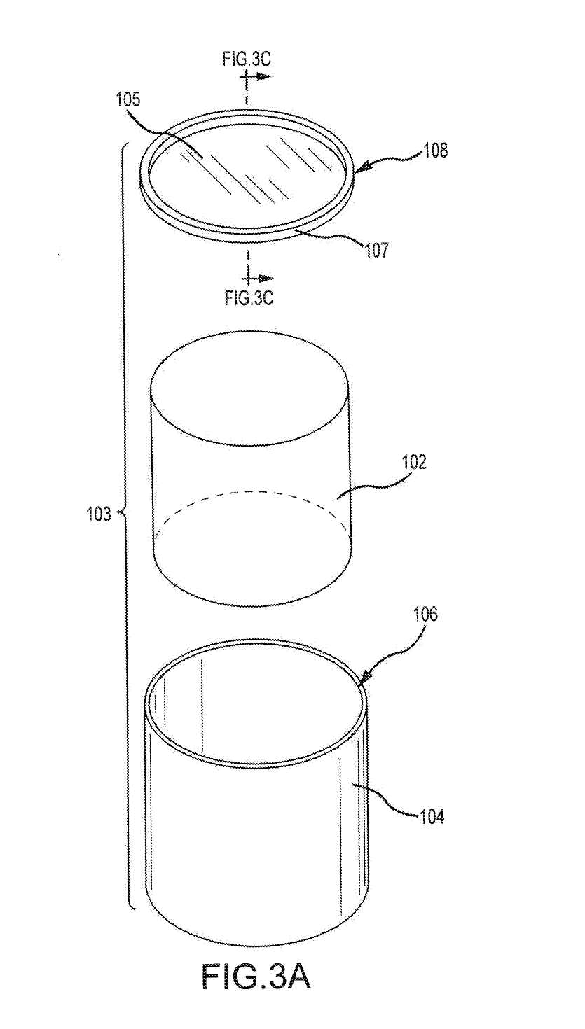

An exemplary first embodiment of a scintillation detector assembly 100 is shown in FIG. 1. The assembly 100 includes a scintillator composition 102 enclosed in a cup shaped container 104 that has an open end 106. A transparent window 108 is press fit into and closes the open end 106 to enclose the scintillator composition 102 and form a mechanical hermetic seal over the composition 102.

A sensing end of a photomultiplier tube 109 is positioned adjacent the window 108 closing the container 104 to sense any light passing through the window 108, converting the sensed light into electrical pulses for subsequent signal processing and analysis.

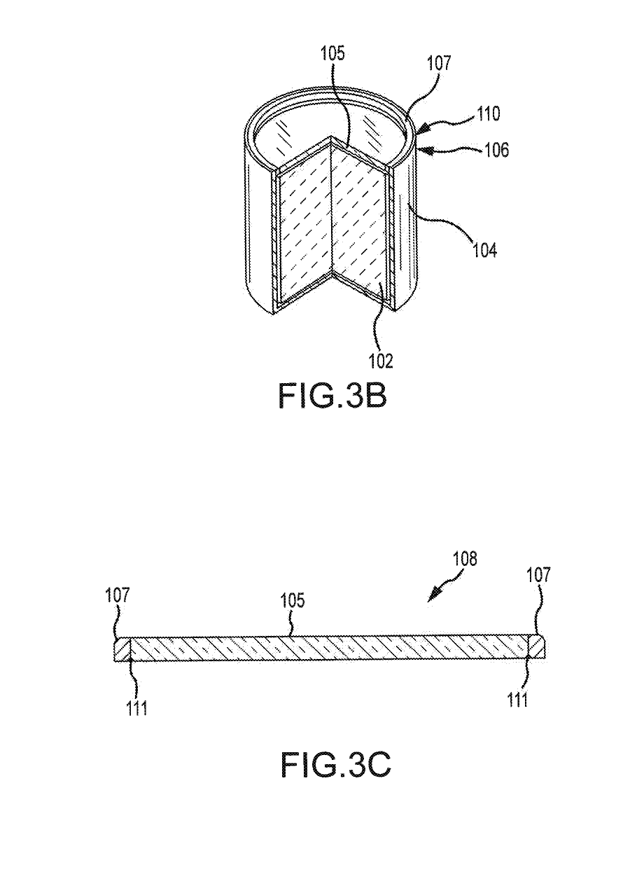

An exploded view of the scintillator container assembly 103 is shown in FIG. 3A. The scintillator container assembly 103 includes the cup shaped container 104, the scintillator composition 102, and the transparent closure window assembly 108. Together the container 104 and window assembly 108 form a hermetically sealed enclosure around the scintillator composition 102 within the container 104. The hermetic seal is preferably formed in accordance with the present disclosure via mechanical compressive forces exerted by a metal rim 107 around the glass disc 105. An epoxy layer 111 may be provided around the rim of the glass disk 105. The optical epoxy layer 111 is provided following installation of the metal rim 107 to secure the seal between rim 107 and glass 105 in case of industrial imperfection of joint surfaces. This rim 107 is then welded to the open end of the container 104 to complete closure of the assembly 103.

The container 104 may be preferably formed of 2024 or 3003 Aluminum. Similarly, the rim 107 may preferably be formed also of 2024 or 3003 aluminum. Alternatively another aluminum or aluminum alloy composition could be utilized in accordance with the present disclosure.

The rim 107 has an internal diameter at normal room temperature 1 micron to 10 microns less than the outer diameter of the window glass 105. The window assembly 108 is put together by separately heating the rim 107 to a temperature sufficient to expand the inner diameter of the rim 107 to slightly greater than that of the window glass disc 105. This temperature, is at least 150 C and preferably within a range of 100 C to 300 C. As but one example, the heated diameter of the rim 110 is preferably between 0.002 inch and 0.004 inch greater than the diameter of the window 108 for an exemplary 1 inch diameter scintillation detector assembly 100.

The rim 107 is then placed around the window glass 105 and allowed to cool to ambient temperature. This causes the rim 107 to contract and mechanically compress against and seal the rim 17 against the outer edge of the window glass disc 105. This completes the assembly of the window 108.

Next, the window assembly 108 is optically coupled to the scintillator 102 and the together inserted into the container 104 with the assembly 108 positioned on the open end 106 of the container 104 containing the scintillator composition inside. Then the rim 107 is preferably laser welded to the open end 106 of the container 104 to complete the assembly 103. In this embodiment the hermetic seal is formed by the hoop stresses exerted by the inner surface of the rim 107 pressing against the outer edge surface of the window glass disc 105.

A completed assembly 103 is shown in FIG. 3B. The rim 107 is preferably laser welded at 110 to the open end 106 of the container 104. In FIG. 3A, the rim 107 is shown fitting flush within the open end 106. Therefore the laser weld is around the top outer corner of the rim 107 where it is flush with the open end 106. Alternatively the window assembly 108 may be sized such that the rim 107 sits on top of the open end 106. In this case, the laser weld would be to the open end 106 around the bottom outer corner of the rim 107. Other alternative rim configurations are envisioned as well. The rim 107 may have a stepped or an L shaped cross section shape such that it only partially fits within the open end 106. In any of these alternatives however, it remains the compressive mechanical forces exerted radially inwardly on the periphery of the window glass disc that create the hermetic seal in accordance with this disclosure.

An enlarged sectional view of the window assembly 108 is shown in FIG. 3C. Window assembly 108 may include a clear optical epoxy layer 111 around the window glass 105 and the rim 107. A chamfer edge to at least one corner of the perimeter of the glass 105 may be provided to receive this epoxy layer 111. This layer 111 does not perform a sealing function. Instead, the epoxy layer 111 is applied around the perimeter of the glass 105 after the rim 107 is installed and cooled. The optical epoxy layer 111 is provided to secure the seal between rim 107 and glass 105 in case of industrial imperfection of joint surfaces. For example, small dust particles may prevent a proper hermetic seal from forming. Thus a potting material is preferred in industrial assembly environments. The seal function is performed by the mechanical compression between the rim 107 and the glass 105. This clear epoxy seal 111 is a clear potting material with good adhesion to glass and aluminum. One suitable optical epoxy currently available is a clear epoxy such as 10-3713 or 20-3302NCLV from Epoxy Etc. (www.epoxy.com).

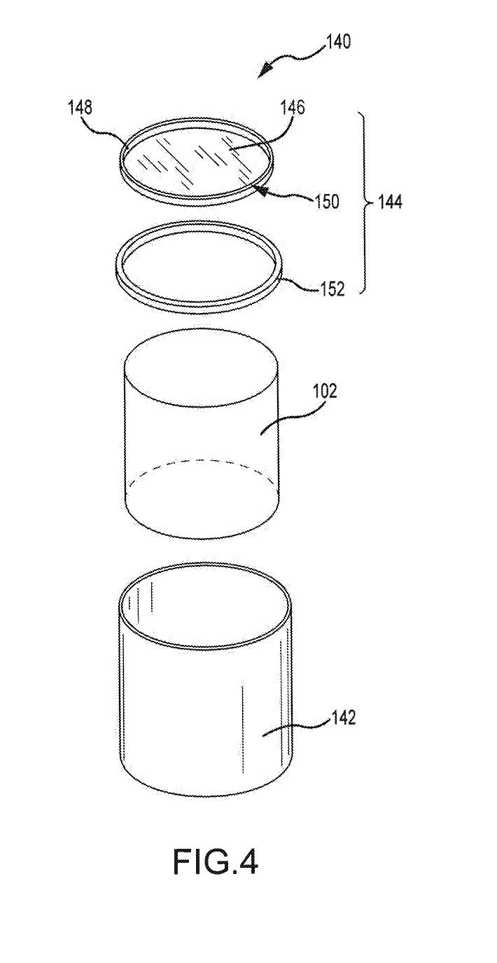

An exploded view of a second exemplary embodiment of a sealed scintillator container 140 in accordance the present disclosure is shown in FIG. 4. In this second exemplary embodiment 140 the scintillator composition 102 is optically coupled to a window assembly 144 and then placed within the cup shaped container 142. The window assembly 144 is then laser welded to the open end of the cup shaped container 142. The window assembly 144 includes a window glass disc 146 having a peripheral edge surface 148. A layer 150 of aluminum is deposited, preferably via vacuum deposition, onto the peripheral edge surface 148 such that the layer 150 extends completely around the glass disc 146. Then, an annular rim 152 is then installed onto the glass disc 146 to complete the window assembly 144. This rim 152 again is sized, at normal room temperature, slightly smaller in inside diameter, than the outer diameter of the glass disc 146 with layer 150 deposited thereon. The rim 152 is separately heated to expand the rim 152 to an inner diameter greater than the outer diameter of the layered disc 146 and then placed onto the layered disc 146. The rim 152 is then allowed to cool, contracting so as to apply a compressive force against the layer 150 and in turn disc 146. The layer 150 may be between 1 and 20 microns thick and preferably about 10 microns thick. Together the window assembly 144 may have an outer diameter dimension as in the first embodiment described above with reference to FIGS. 3 and 3a. The window assembly 144 is then placed on the container 142 and laser welded thereto as above described.

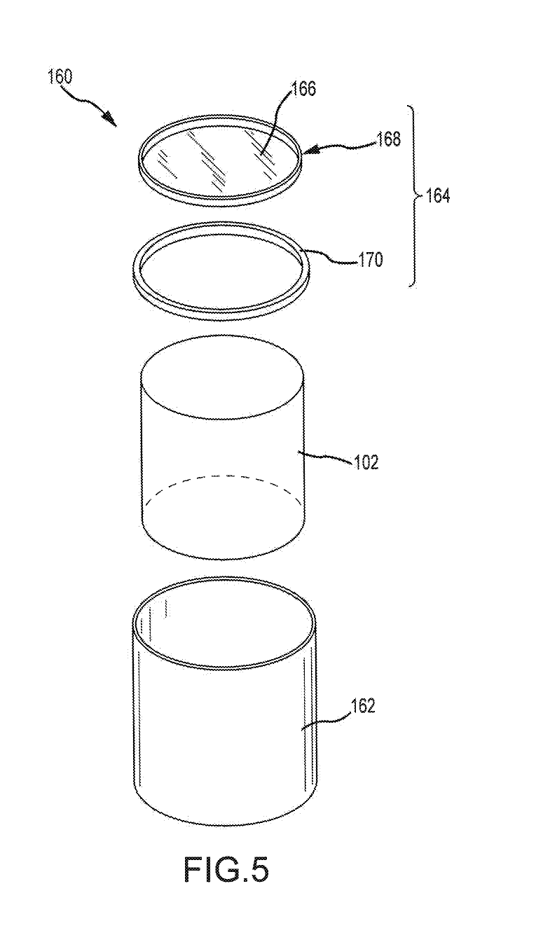

Another exemplary embodiment of a sealed scintillator container 160 is shown in FIG. 5. The sealed scintillator container 160 includes a cup shaped container 162 in which a scintillator composition 102 is placed. The window assembly 164 in this embodiment is a glass disc 166 melted in place within and fused to an annular ring 168 made of stainless steel. A separate annular rim 170 is press fit tightly around the annular ring 168. This annular rim 170 applies a compressive force radially inward on the ring 168 to form a hermetic seal. The completed window assembly 164 is then optically coupled to the scintillator composition 102 and together placed into the container 162 and the window assembly 164 placed on the open end of the container 162 and again laser welded thereto as in the previously described embodiments.

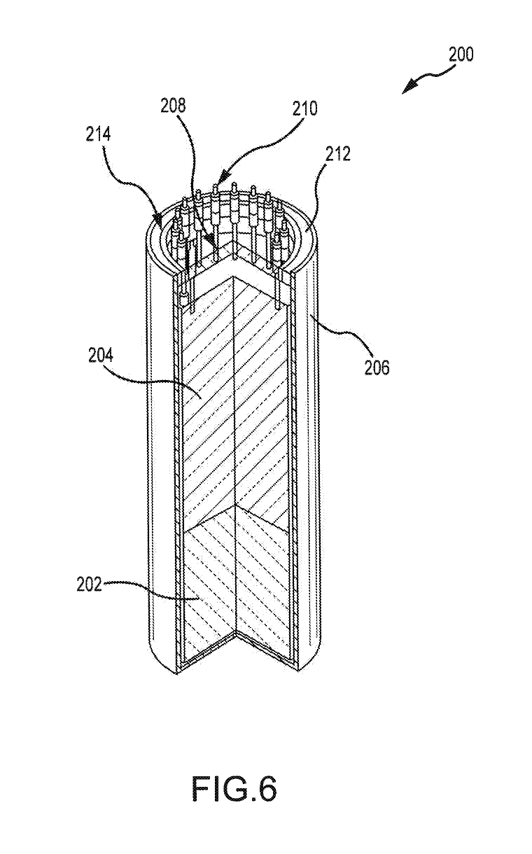

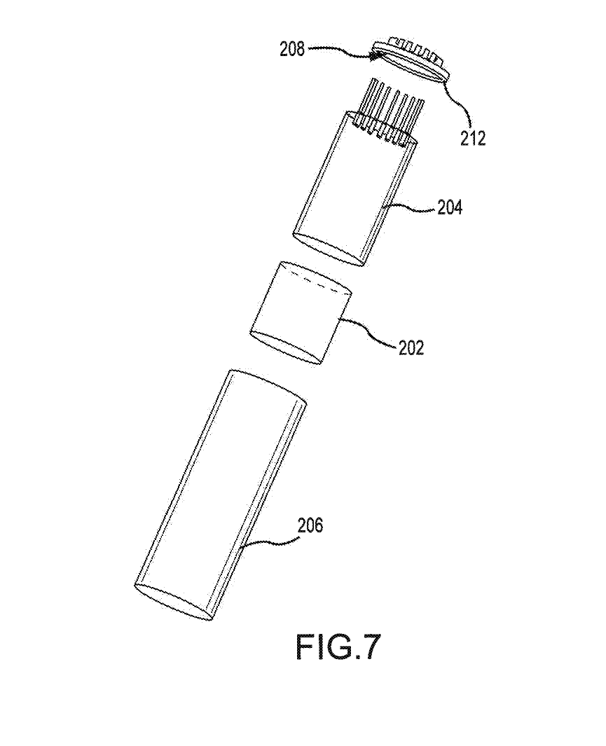

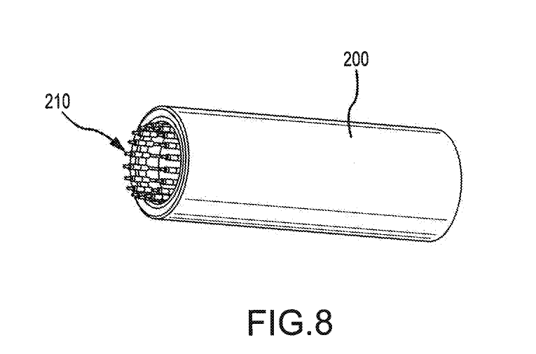

A scintillation assembly 200 in accordance with the present disclosure is shown in FIGS. 6, 7, and 8. An upright perspective view of the assembly is shown in FIG. 6, with portions shown in section. An exploded view of the assembly 200 is shown in FIG. 7. An assembled perspective view of the assembly is shown in FIG. 8.

The assembly 200 includes a scintillation crystal 202 and a photomultiplier tube (PMT) subassembly 204 optically coupled thereto and placed together in an aluminum tubular housing 206 without the use of a glass window assembly as in the prior described embodiments. The PMT in this embodiment is placed directly against the scintillator crystal composition 202. A glass lead pass-through 208 is fastened to the leads exiting the PMT.

This pass-through 208 is a circular glass disc separately formed as a glass melt formed around a circular arrangement of electrical connector pins 210. An aluminum rim 212 is press fit onto the outer rim 214 of the disc 208 to form a mechanical hermetic seal between the pass-through disc 208 and the rim 212. The connector pins 210 of the assembled pass-through 208 are then soldered to the appropriate leads of the photomultiplier tube 204. The assembled PMT subassembly 204 with pass-through 208 attached is then placed within the housing 206 directly against the scintillator crystal composition 202. The aluminum ring or rim 212 is then laser welded to the housing 206 to complete the detector assembly. A hermetic seal is provided in this embodiment by the compressive mechanical fit between the pass-through disc 208 and the rim 212.

Many changes will suggest themselves to an ordinary person skilled in the art of detector design. For example, the detector assembly shown in FIGS. 6, 7 and 8 may include rim configurations as shown in FIG. 3, 4 or 5. Also, if a potting compound such as an epoxy is used, it may be optically clear or opaque, depending on the particular application. For example, such a potting compound layer 111 may be provided around the edge 148 between the glass and the vapor deposited aluminum layer 150 in the embodiment shown and described with reference to FIG. 4. Optionally, an opaque potting compound may be utilized between compressed metal to aluminum seals such as between layer 150 and the rim 152. Furthermore, other materials than aluminum may be utilized with the teachings of the present disclosure.

Accordingly, all such changes, alternatives and equivalents in accordance with the features and benefits described herein, are within the scope of the present disclosure. Such changes and alternatives may be introduced without departing from the spirit and broad scope of my invention as defined by the exemplary claims below and their equivalents.

What is claimed is:

1. A hermetically sealed scintillator container assembly comprising:
a cup shaped container sized to receive and hold a scintillator composition, the container having an open end;
a disc shaped container closure window having a perimeter; and
an annular metal rim compressively fit around the window and mechanically pressing against the perimeter of the window so as to form a hermetic seal between the window and the rim, wherein the rim is laser welded to the open end of the container to enclose the scintillator composition within the container.

2. The assembly according to claim 1 wherein the window has a layer of aluminum around an outer rim portion of the window.

3. The assembly according to claim 1 wherein the window has a metal ring around an outer rim portion of the window.

4. The assembly according to claim 1 further comprising a potting compound layer between the perimeter of the window and the metal rim.

5. The assembly according to claim 4 wherein the potting compound layer is a clear epoxy layer.

6. A scintillation detector assembly comprising:
a tubular housing;
a scintillator container assembly in the housing, the assembly comprising:
a cup shaped container sized to receive and hold a scintillator composition, the container having an open end;
a disc shaped container closure window having a perimeter; and
an annular metal rim compressively fit around the window and mechanically pressing against the perimeter of the window so as to form a hermetic seal between the window and the rim, wherein the rim is laser welded to the open end of the container to enclose the scintillator composition within the container, within the housing;
a photomultiplier tube having one end positioned against the window, the photomultiplier tube having a plurality of electrical connector leads protruding from another end;
a glass pass-through having a plurality of connector pins coupled to the connector leads, and
another metal rim compressively fit around the peripheral edge of the pass-through, wherein the another rim is welded to the housing and wherein the compressive mechanical fit between the pass-through and the another rim hermetically seals the photomultiplier tube and scintillator container assembly within the tubular housing.

7. The assembly according to claim 6 further comprising a metal ring fused to the glass pass-through to which the another metal rim is compressively fit.

8. The assembly according to claim 6 wherein the another metal rim is aluminum.

9. The assembly according to claim 6 further comprising a potting compound layer between the metal rim and the closure window.

10. The assembly according to claim 9 wherein the potting compound is an epoxy.

11. A scintillation detector assembly comprising:
a tubular housing;
a scintillator composition contained within the housing;
a photomultiplier tube having one end positioned against the scintillator composition, the photomultiplier tube having a plurality of electrical connector leads protruding from another end; and
a glass pass-through having a plurality of connector pins coupled to the connector leads, and
a metal rim compressively fit around the peripheral edge of the pass-through, wherein the rim is welded to the housing and wherein the compressive mechanical fit between the pass-through and the rim hermetically seals the photomultiplier tube and scintillator composition within the tubular housing.

12. The assembly according to claim 11 further comprising a metal ring fused to the glass pass-through to which the metal rim is compressively fit.

13. The assembly according to claim 11 wherein the metal rim is aluminum.
